(19) United States
(12) Patent Application Publication
(10) Pub. No.: US 2023/0086248 A1
(43) Pub. Date: Mar. 23, 2023

(54) VISUAL NAVIGATION ELEMENTS FOR ARTIFICIAL REALITY ENVIRONMENTS

(71) Applicant: Meta Platforms Technologies, LLC, Menlo Park, CA (US)

(72) Inventors: Ana Garcia Puyol, Mountain View, CA (US); Michelle Pujals, Los Gatos, CA (US); John Nicholas Jitkoff, Seattle, WA (US); Amir Mesguich Havilio, San Francisco, CA (US); Jesse John Mullen, Hayward, CA (US); Cristobal Alvaro Castilla Lacomba, Seattle, WA (US)

(21) Appl. No.: 17/481,196

(22) Filed: Sep. 21, 2021

(51) Int. Cl. G06F 3/0481; G06F 16/955; H04L 29/06; G06T 19/00

(52) U.S. Cl. CPC G06F 3/04815; G06F 16/9558; H04L 67/38; G06T 19/006

(57) ABSTRACT

Various aspects of the subject technology relate to systems, methods, and machine-readable media for providing and activating a link to artificial reality content in a shared artificial reality environment. Various aspects may include receiving a request to generate a visual navigation element for an artificial reality application configured to operate in the shared artificial reality environment, such as via a user representation. Aspects may include generating the visual navigation element and generating an audio element indicative of another user representation engaged in the artificial reality application for the user representation. Aspects may also include receiving an indication of activation of the visual navigation element and loading the artificial reality application for the user representation upon activation and while providing the audio element. Aspects may also include providing instructions to display the user representation in the artificial reality application upon completion of the loading.

### TECHNICAL FIELD

The present disclosure generally relates to creating and administering visual navigation elements for artificial reality environments having artificial reality applications.

### BACKGROUND

Interaction between various people over a shared artificial reality environment involves a variety of types of interaction such as sharing individual experiences in the shared artificial reality environment. The shared artificial reality environment may have artificial reality elements such as virtual reality elements. Virtual reality elements that facilitate collaboration between people may enhance a person or user's experience in the shared artificial reality environment. For example, the person or user may feel more connected to other people or users in the shared artificial reality environment.

### BRIEF SUMMARY

The subject disclosure provides for systems and methods for interaction with virtual reality applications in a virtual reality environment. In an aspect, a visual navigation element may be used to control selection of and interaction with one or more virtual reality applications. For example, the visual navigation element may be a virtual reality orb. The interaction may include receiving instructions from a user to load a particular virtual reality application in a particular visual navigation element. While the particular virtual reality application is loading, the user may receive an indication of engagement in the virtual reality environment by other users associated with the user. For example, the user may hear the user's friends playing a virtual reality game application while a virtual reality application selected by the user is loading. After the virtual reality application has loaded for the user, a representation of the user being engaged in the virtual reality application may be rendered or presented in the virtual reality environment.

According to one embodiment of the present disclosure, a computer-implemented method for activating a link to artificial reality content in a shared artificial reality environment is provided. The method includes receiving a request to generate a visual navigation element for an artificial reality application configured to operate in the shared artificial reality environment. Receiving the request may occur via a user representation in a shared artificial reality environment. The method also includes generating the visual navigation element in the shared artificial reality environment. The method also includes generating, for the user representation, an audio element indicative of another user representation engaged in the artificial reality application. The method also includes receiving an indication that the user representation has activated the visual navigation element. The method also includes loading, upon activation of the visual navigation element and while providing the audio element indicative of the another user representation engaged in the artificial reality application, the artificial reality application for the user representation. The method also includes providing instructions to display the user representation in the artificial reality application upon completion of the loading.

According to one embodiment of the present disclosure, a system is provided including a processor and a memory comprising instructions stored thereon, which when executed by the processor, causes the processor to perform a method for activating a link to artificial reality content in a shared artificial reality environment. The method includes receiving a request to generate a visual navigation element for an artificial reality application configured to operate in the shared artificial reality environment. Receiving the request may occur via a user representation in a shared artificial reality environment. The method also includes generating the visual navigation element in the shared artificial reality environment. The method also includes generating an audio element indicative of a first user representation engaged in the artificial reality application. The audio element is audible to a second user representation. The method includes sending a message between the first user representation and the second user representation. The method also includes receiving, based on the message, an indication that the second user representation has activated the visual navigation element. The method also includes loading, upon activation of the visual navigation element and while providing the audio element indicative of the first user representation engaged in the artificial reality application, the artificial reality application for the second user representation. The method also includes providing instructions to display the user representation in the artificial reality application upon completion of the loading.

According to one embodiment of the present disclosure, a non-transitory computer-readable storage medium is provided including instructions (e.g., stored sequences of instructions) that, when executed by a processor, cause the processor to perform a method for providing a link to artificial reality content in a shared artificial reality environment. The method includes receiving a request to generate a visual navigation element for an artificial reality application configured to operate in the shared artificial reality environment. Receiving the request may occur via a user representation in a shared artificial reality environment. The method also includes generating the visual navigation element in the shared artificial reality environment. The method also includes generating, for the user representation, an audio element indicative of another user representation engaged in the artificial reality application. The method also includes receiving an indication that the user representation has activated the visual navigation element. The method also includes loading, upon activation of the visual navigation element and while providing the audio element indicative of the another user representation engaged in the artificial reality application, the artificial reality application for the user representation. The method also includes providing instructions to display the user representation in the artificial reality application upon completion of the loading.

According to one embodiment of the present disclosure, a system is provided that includes means for storing instructions, and means for executing the stored instructions that, when executed by the means, cause the means to perform a method for activating a link to artificial reality content in a shared artificial reality environment. The method includes receiving a request to generate a visual navigation element for an artificial reality application configured to operate in the shared artificial reality environment. Receiving the request may occur via a user representation in a shared artificial reality environment. The method also includes generating the visual navigation element in the shared artificial reality environment. The method also includes generating, for the user representation, an audio element indicative of another user representation engaged in the artificial reality application. The method also includes receiving an indication that the user representation has activated the visual navigation element. The method also includes loading, upon activation of the visual navigation element and while providing the audio element indicative of the another user representation engaged in the artificial reality application, the artificial reality application for the user representation. The method also includes providing instructions to display the user representation in the artificial reality application upon completion of the loading.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIGS. 2A-2B are diagrams illustrating virtual reality headsets, according to certain aspects of the present disclosure.

FIG. 2C illustrates controllers for interaction with an artificial reality environment.

FIG. 3 is a block diagram illustrating an overview of an environment in which some implementations of the present technology can operate.

FIGS. 4A-4B illustrate example views of a user interface in an artificial reality environment, according to certain aspects of the present disclosure.

FIGS. 5A-5B illustrate example views of a user interface for transition between portions of an artificial reality environment, according to certain aspects of the present disclosure.

FIG. 6 illustrates an example view of an artificial reality collaborative working environment, according to certain aspects of the present disclosure.

FIGS. 7A-7B illustrate example views of artificial reality environments for selecting a link to artificial reality content, according to certain aspects of the present disclosure.

FIGS. 8A-8B illustrate example views of generating and activating a link to artificial reality content, according to certain aspects of the present disclosure.

FIGS. 9A-9B illustrate example views of activating a link to artificial reality content according to a user representation engaged in an artificial reality application, according to certain aspects of the present disclosure.

FIGS. 10A-10B illustrate example views of loading artificial reality content according to a user representation engaged in an artificial reality application, according to certain aspects of the present disclosure.

FIGS. 11A-11B illustrate example views of engagement in artificial reality content according to a user representation engaged in an artificial reality application, according to certain aspects of the present disclosure.

FIGS. 12A-12B illustrate example views of generating audio indications for user representations that are associated with each other, according to certain aspects of the present disclosure.

FIG. 13 is an example flow diagram for activating a link to artificial reality content in a shared artificial reality environment, according to certain aspects of the present disclosure.

FIG. 14 is a block diagram illustrating an example computer system which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The disclosed system addresses a problem in virtual or artificial reality tied to computer technology, namely, the technical problem of communication and interaction between artificial reality user representations within a computer generated shared artificial reality environment. The disclosed system solves this technical problem by providing a solution also rooted in computer technology, namely, by providing a link to artificial reality content in the shared artificial reality environment. The disclosed system also improves the functioning of the computer itself because it enables the computer to improve intra computer communications for the practical application of a system of computers generating and hosting the shared artificial reality environment. In particular, the disclosed system provides improved artificial reality elements that improve communication between user representations within the computer generated shared artificial reality environment.

Aspects of the present disclosure are directed to creating and administering artificial reality environments. For example, an artificial reality environment may be a shared artificial reality (AR) environment, a virtual reality (VR), an extra reality (XR) environment, an augmented reality environment, a mixed reality environment, a hybrid reality environment, a non immersive environment, a semi immersive environment, a fully immersive environment, and/or the like. The artificial reality environments may also include collaborative working environments which include modes for interaction between various people or users in the XR environments. The XR environments of the present disclosure may provide elements that enable users to feel connected with other users. For example, audio and visual elements may be provided that maintain connections between various users that are engaged in the XR environments. As used herein, “real-world” objects are non-computer generated and AR or VR objects are computer generated. For example, a real-world space is a physical space occupying a location outside a computer and a real-world object is a physical object having physical properties outside a computer. For example, an AR or VR object may be rendered and part of a computer generated XR environment.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they passthrough the system, such as by adding virtual objects. “Mixed reality” or “MR” refers to systems where light entering a user's eye is partially generated by a computing system and partially composes light reflected off objects in the real-world. For example, a MR headset could be shaped as a pair of glasses with a pass-through display, which allows light from the real-world to passthrough a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

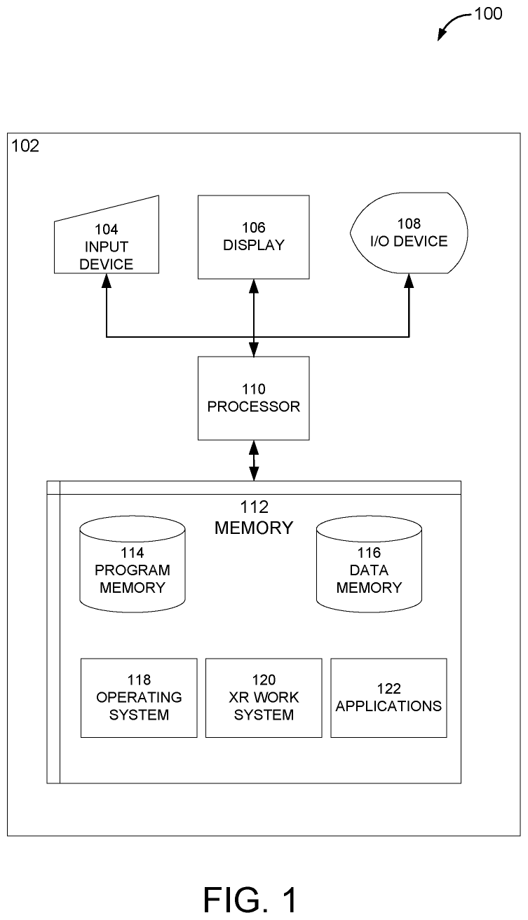

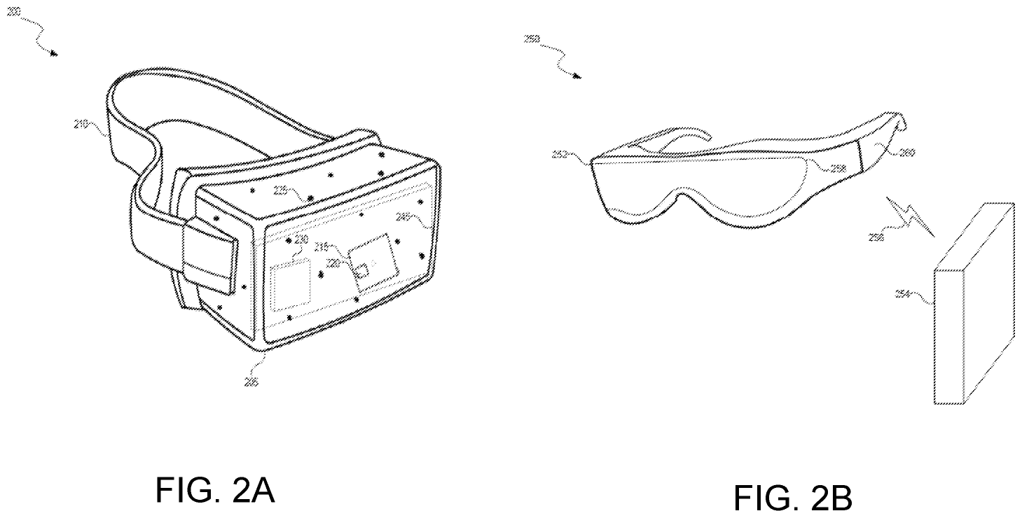

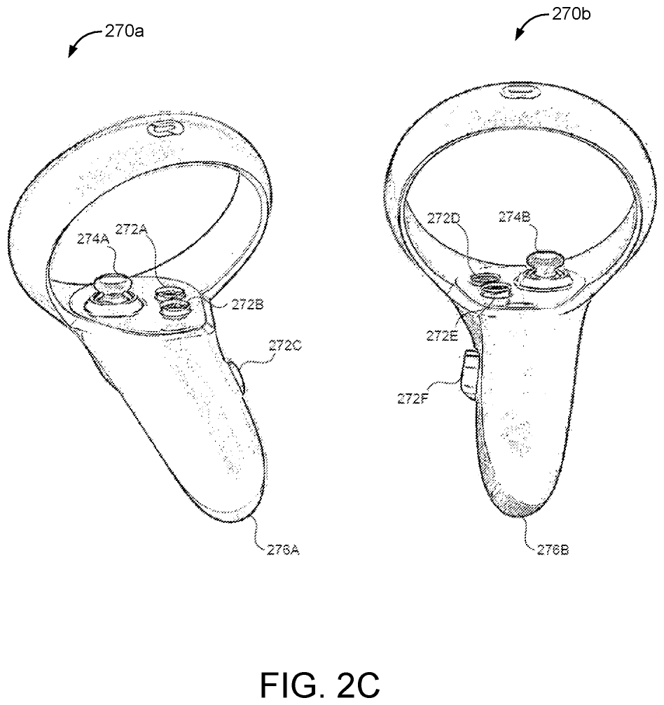

Several implementations are discussed below in more detail in reference to the figures. FIG. 1 is a block diagram of a device operating environment with which aspects of the subject technology can be implemented. The devices can comprise hardware components of a computing system 100 that can create, administer, and provide interaction modes for an artificial reality collaborative working environment. In various implementations, computing system 100 can include a single computing device or multiple computing devices that communicate over wired or wireless channels to distribute processing and share input data. In some implementations, the computing system 100 can include a stand-alone headset capable of providing a computer created or augmented experience for a user without the need for external processing or sensors. In other implementations, the computing system 100 can include multiple computing devices such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices can include sensor components that can track environment or position data.

The computing system 100 can include one or more processor(s) 110 (e.g., central processing units (CPUs), graphical processing units (GPUs), holographic processing units (HPUs), etc.) The processors 110 can be a single processing unit or multiple processing units in a device or distributed across multiple devices (e.g., distributed across two or more of computing devices).

The computing system 100 can include one or more input devices 104 that provide input to the processors 110, notifying them of actions. The actions can be mediated by a hardware controller that interprets the signals received from the input device and communicates the information to the processors 110 using a communication protocol. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

Processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, display 106 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices or a network node. The communication device can communicate with another device or a server through a network using, for example, TCP/IP protocols. The computing system 100 can utilize the communication device to distribute operations across multiple network devices.

The processors 110 can have access to a memory 112, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122. The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real-world and in a virtual environment in three degrees of freedom (3DoF), six degrees of freedom (6DoF), etc. For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real-world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270a-270b, which, in some implementations, a user can hold in one or both hands to interact with an artificial reality environment presented by the HMD 200 and/or HMD 250. The controllers 270a-270b can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers 270a-270b can also include various buttons (e.g., buttons 272A-F) and/or joysticks (e.g., joysticks 274A-B), which a user can actuate to provide input and interact with objects. As discussed below, controllers 270a-270b can also have tips 276A and 276B, which, when in scribe controller mode, can be used as the tip of a writing implement in the artificial reality working environment.

In various implementations, the HMD 200 or 250 can also include additional subsystems, such as an eye tracking unit, an audio system, various network components, etc. To monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions.

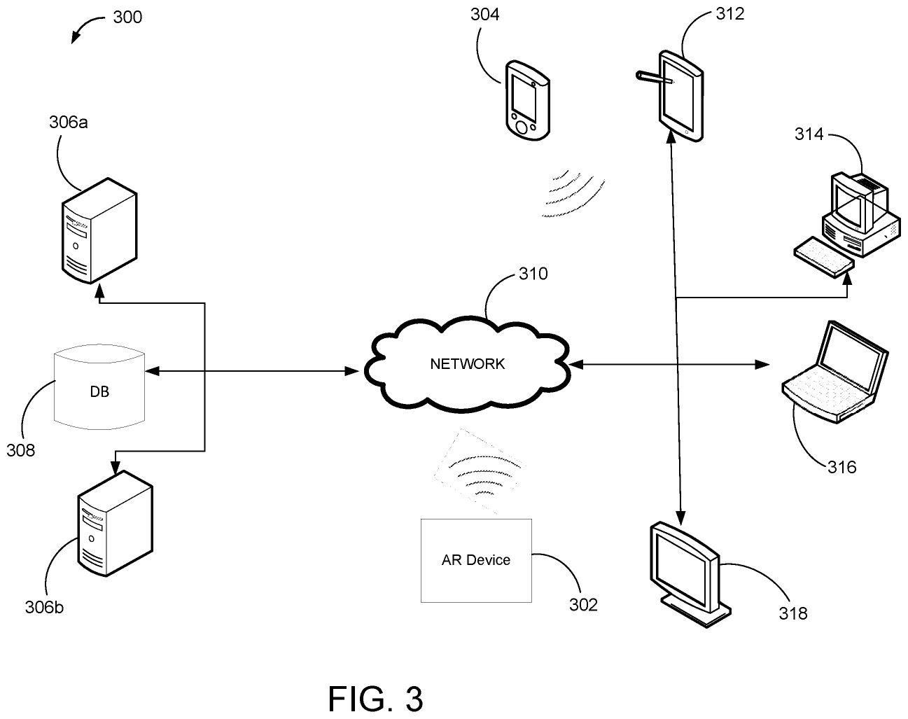

FIG. 3 is a block diagram illustrating an overview of an environment 300 in which some implementations of the disclosed technology can operate. Environment 300 can include one or more client computing devices, such as artificial reality device 302, mobile device 304 tablet 312, personal computer 314, laptop 316, desktop 318, and/or the like. The artificial reality device 302 may be the HMD 200, HMD system 250, or some device that is compatible with rendering or interacting with an artificial reality or virtual reality environment. The artificial reality device 302 and mobile device 304 may communicate wirelessly via the network 310. In some implementations, some of the client computing devices can be the HMD 200 or the HMD system 250. The client computing devices can operate in a networked environment using logical connections through network 310 to one or more remote computers, such as a server computing device.

In some implementations, the environment 300 may include a server such as an edge server which receives client requests and coordinates fulfillment of those requests through other servers. The server may include server computing devices 306a-306b, which may logically form a single server. Alternatively, the server computing devices 306a-306b may each be a distributed computing environment encompassing multiple computing devices located at the same or at geographically disparate physical locations.

The client computing devices and server computing devices 306a-306b can each act as a server or client to other server/client device(s). The server computing devices 306a-306b can connect to a database 308. Each server computing devices 306a-306b can correspond to a group of servers, and each of these servers can share a database or can have their own database. The database 308 may logically form a single unit or may be part of a distributed computing environment encompassing multiple computing devices that are located within their corresponding server, or located at the same or at geographically disparate physical locations.

The network 310 can be a local area network (LAN), a wide area network (WAN), a mesh network, a hybrid network, or other wired or wireless networks. The network 310 may be the Internet or some other public or private network. Client computing devices can be connected to network 310 through a network interface, such as by wired or wireless communication. The connections can be any kind of local, wide area, wired, or wireless network, including the network 310 or a separate public or private network.

In some implementations, the server computing devices 306a-306b can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

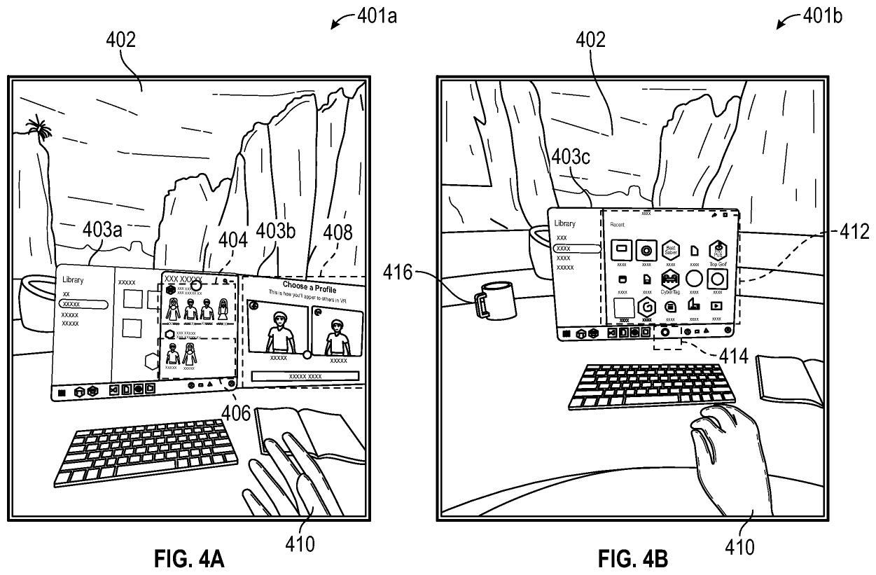

FIGS. 4A-4B illustrate example views of a user interface in artificial reality environments 401a-401b, according to certain aspects of the present disclosure. For example, the artificial reality environment may be a shared artificial reality (AR) environment, a virtual reality (VR), an augmented reality environment, a mixed reality environment, a hybrid reality environment, a non immersive environment, a semi immersive environment, a fully immersive environment, and/or the like. The XR environments 401a-401b may be presented via the HMD 200 and/or HMD 250. For example, the XR environments 401a-401b may include virtual objects such as a keyboard, a book, a computer, and/or the like. The virtual objects can be mapped from real world objects such as a real world office of a user. As an example, the controllers in the mixed reality HMD 252 can convert the image data into light pulses from the projectors in order to cause a real world object such as a coffee cup to appear as a mapped virtual reality (VR) coffee cup object 416 in the XR environment 401b. In this way, as an example, if the user moves the real world coffee cup, motion and position tracking units of the HMD system 250 may cause the user caused movement of the real world coffee cup to be reflected by motion of the VR coffee cup object 416.

The XR environments 401a-401b may include a background 402 selected by the user. For example, the user can select a type of geographic environment such as a canyon, a desert, a forest, an ocean, a glacier and/or the like. Any type of suitable stationary or non-stationary image may be used as the user selected background 402. The XR environments 401a-401b may function as a VR office for the user. The VR office may include user interfaces for selection of parameters associated with the shared XR environment, such as a user interface of a computer virtual object or display screen virtual object. For example, the XR environments 401a-401b may include display screen virtual objects 403a-403c. The display screens 403a-403c can be mixed world objects mapped to a real world display screen, such as a computer screen in the user's real world office. The display screens 403a-403c may render pages or visual interfaces configured for the user to select XR environment parameters. For example, the user may configure the XR environments 401a-401b as a personal workspace that is adapted to user preferences and a level of immersion desired by the user. As an example, the user can select to maintain the user's access to real-world work tools such as the user's computer screen, mouse, keyboard, or to other tracked objects such as a coffee mug virtual object 416 while the user is inside the XR environments 401a, 401b. In this way, the user's interactions with a real world coffee mug may be reflected by interaction of a user representation corresponding to the user with the coffee mug virtual object 416.

Also, the XR environments 401a, 401b includes computer display screens 403a-403c that display content, such as on a workstations (e.g., browser window). The browser window can be used by the user to select AR parameters or elements such as a user representation, a virtual area, immersive tools, and/or the like. For example, the user may select that their user representation should be an avatar, a video representation (e.g., video screen virtual object that shows a picture of the user, another selected picture, a video feed via a real world camera of the user, etc.), or some other suitable user representation. The browser window may be linked to a real world device of the user. As an example, the browser window may be linked to a real world browser window rendered on a real world computer, tablet, phone, or other suitable device of the user. This way, the user's actions on the real world device may be reflected by one or more of the corresponding virtual display screens 403a-403c.

The mixed reality HMD system 250 may include a tracking component (e.g., position sensor, accelerometer, etc.) that tracks a position of the real world device screen, device input (e.g., keyboard), user's hands, and/or the like to determine user commands or instructions input in the real word. The mixed reality HMD system 250 can cause the user input to be reflected and processed in the XR environments 401a-401b. This enables the user to select a user representation for use in the shared XR environment, such as one of the avatars shown in the display screen 403a. The selected user representation may be configured for display in various virtual areas of the shared XR environment. The profile selection area 408 may also include options to select how the user should appear during meetings in the shared XR environment. For example, during a meeting in an immersive space between multiple users, the user may select to join via a video representation at a table virtual object. As an example, a video feed of the user linked to a real world camera may be used to display a screen virtual object at a seat virtual object of a conference table virtual object. The user may be able to select options such as switching between various seats at the conference table, panning a view of the user around the virtual area where the meeting occurs, and/or the like. As an example, the user may select an embodied avatar, such as an avatar that appears as a human virtual object.

In this way, the user selected avatar may track the user's real world expressions, such as via the tracking component of the mixed reality HMD system 250. For example, the user's facial expressions (e.g., blinking, looking around, etc.) may be reflected by the avatar. The user may also indicate relationships with other users, so as to make connections between various user representations. For example, the user may indicate through user input which user representations are considered friends or family of the user. The user input may involve dragging and dropping representations of the friends or family via a real world mouse onto a real world display screen, clicking on a real world mouse, using the virtual object controllers 270a-270b, or some other suitable input mechanism. User inputs entered via a real world object may be reflected in the shared XR environment based on the mixed reality HMD system 250. The user may use a user input via a user device (e.g., real world computer, tablet, phone, VR device, etc.) to indicate the appearance of their corresponding user representation in the profile selection area 408 so that other associated user representations recognize the user's user representation. The online or offline status of user representations associated with the user can be shown in the avatar online area 404 of the display screen 403a. For example, the avatar online area 404 can graphically indicate which avatars (e.g., avatars associated with the user's user representation) are online and at what locations.

The user may also use a user input to select a profile for the shared XR environment and/or XR environments 401a-401b on a profile selection area 408 of the display screen 403b. The profile for the user may include workspace preferences for the user, such as a size, color, layout, and/or the like of a home office virtual area for the user. The profile may also include options for the user to add contextual tools such as tools for adding content (e.g., AR content), mixed reality objects, sharing content (e.g., casting) with other users, and/or the like. For example, the profile may specify a number of browser windows and define types or instances of content that the user may select to share with other users. For example, the profile may define types or instances of content that the user selects to persistently exist as virtual objects in the user's personal XR environments 401a-401b. The computer display screen 403c may display a browser window having an application library 412 that the user may use to select AR applications. A representation of a hand of the user, such as hand virtual object 410 may be used to select the AR applications.

Also, a cursor or pointer 414 may be used to select one or more instances of the AR applications in the application library 412. For example, the user may move a real world computer mouse that is linked to the tracked same movement of the user's real life hand (e.g., as represented by a computer mouse virtual object moved by a human hand virtual object) in the personal XR environment 401b. Such linking may be achieved by the tracking component of the mixed reality HMD system 250, as described above. As an example, the user may use the virtual object controllers 270a-270b to control the cursor or pointer 414. In this way, the user may select instances of AR applications, which can be represented as graphical icons in the application library 412. For example, the graphical icons can be hexagons, squares, circles, or other suitably shaped graphical icons. The graphical icons that appear in the application library 412 may be sourced from a library of applications, such as based on a subscription, purchase, sharing, and/or the like by the user. As an example, the user may send an indication of a particular AR application to other users (e.g., friends, family, etc.) for sharing, such as to allow the other users to access the particular AR application (e.g., at a particular point), to prompt the other users to access or purchase the application, to send a demo version of the application, and/or the like. The cursor or pointer 414 may be used to indicate or select options displayed on the display screens 403a-403c.

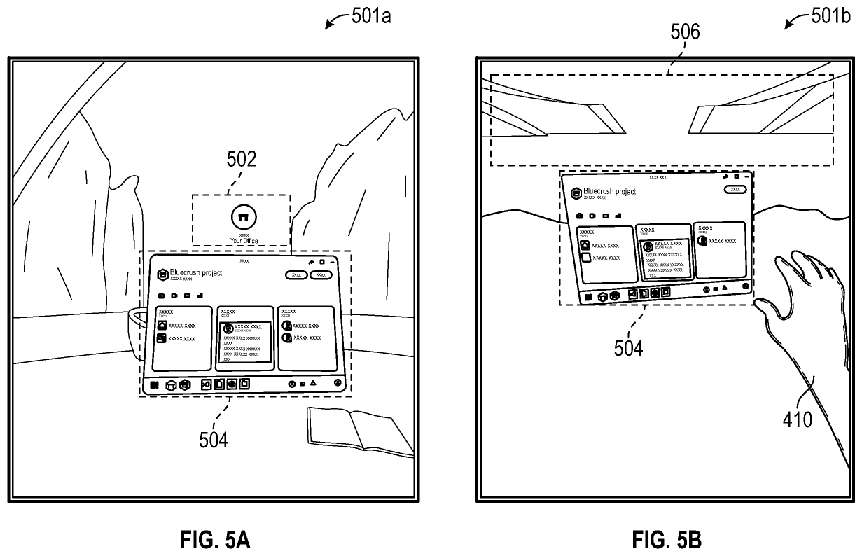

FIGS. 5A-5B illustrate example views of a user interface for transition between portions of a shared XR environment, according to certain aspects of the present disclosure. For example, the XR environments 501a-501b illustrate a stage of a user transitioning from a virtual area to another virtual area. As an example, the user may transition from a personal workspace virtual area to a shared workspace virtual area. The user may indicate a desire to transition from a first virtual area or a selection of a second virtual area via the cursor or pointer 414 (e.g., controlled by the controllers 270a-270b, etc.), the hand virtual object 410, and/or the like. For example, the user may use the home screen 504 to indicate information about the destination (e.g., the another virtual area). As an example, the user may select a shared virtual meeting area to travel to and/or from the personal workspace virtual area. The shared virtual meeting area may correspond to or be labeled “Bluecrush Project.”

The home screen 504 may include information that is useful or relevant to the user, such as events, posts (e.g., social media posts, etc.), indications of other users present in the shared virtual meeting area, and/or the like. The home screen 504 may contain a link (e.g., deep link, etc.) that is selectable by the user to initiate travel to the shared workspace virtual area. When the user selects the link or otherwise indicates a desire to travel to the shared workspace virtual area, the XR environment 501a may display a travel indication icon 502. The travel indication icon 502 may indicate that the user is leaving their office or personal workspace virtual area such as the user traveling to a destination virtual area that is loading, for example. The transition or travel from one virtual area to another virtual area may include loading audio and visual elements associated with the another virtual area. While the audio and/or visual elements are loading, a loading indication 506 may appear.

As an example, the loading indication 506 may appear as a blue colored background, such as a blue light that appears after an origin virtual area disappears and prior to a destination virtual area appears for the user. The home may include an icon to indicate a status of the travel between virtual areas by the user. As an example, while the visual elements of the destination virtual area are still loading (i.e., not completely loaded), audio elements may be active. In this way, the audio elements may enable an immediate or a fast audio transition between the origin virtual area and destination virtual area. The audio elements may indicate what the destination virtual area sounds like, such as modeling or approximating the audio feedback that a person entering or within the vicinity of a destination real world are would hear. For example, the audio elements may be indicative of other users/user representations engaged or present in the destination virtual area. As an example, the audio elements may include sounds of other user representations talking, interacting, or engaged (e.g., using an AR app, playing an AR game, etc.) in the destination virtual area.

The user may use a user input mechanism (e.g., cursor or pointer 414, controllers 270a-270b, hand 410, etc.) to configure their corresponding user representation to hear all of the sounds, all of the user representations, a subset of the user representations or the like in the destination virtual area. As an example, the user can configure their user representation to only hear sounds of user representations corresponding to friends and family of the user. The audio elements may load or be activated for the user before the visual elements load for the user. In this way, the user may hear sounds associated with a destination virtual area before the destination virtual area loads. This can enable the user to feel more connected or better maintain continuity with other associated user representations such as friends, family, coworkers, and/or the like.

For example, multiple user representations may virtually “walk together” into the destination virtual area because the audio elements and/or visual elements may cause the multiple user representations to maintain audio and/or visual contact between themselves. As another example, the audio elements may enable the user to hear sounds associated with the activity of other user representations that the user is associated with, even when the user is not actively traveling between virtual areas. The audio elements and/or visual elements may be a configurable AR setting that the user may activate or deactivate. The user may deactivate the audio elements and/or visual elements when the user desires to turn off user status indications in a shared XR environment, for example.

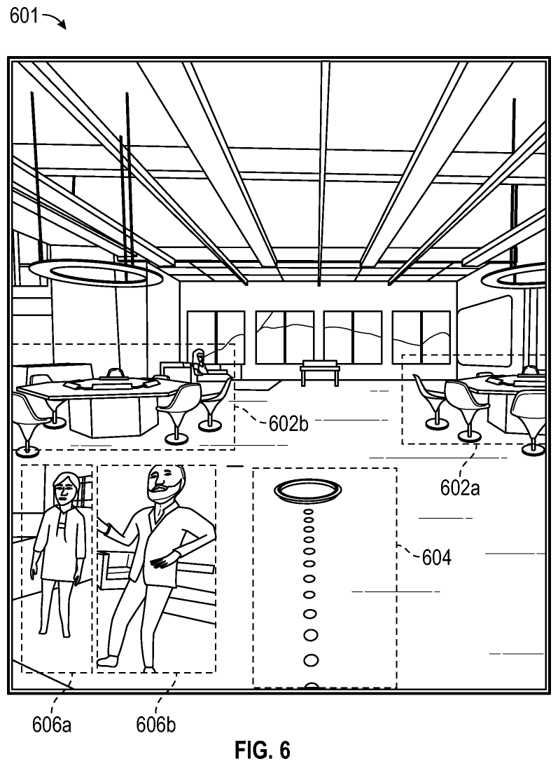

FIG. 6 illustrates an example view of an AR collaborative working environment, according to certain aspects of the present disclosure. The AR collaborative working environment may be a shared AR workspace 601 hosted by a company, for example. The shared AR workspace 601 can comprise virtual objects or formats that mimic real world elements of a real world project space, such as chair virtual objects, conference table virtual objects, presentation surface virtual objects, presentation surfaces (e.g., whiteboards or screens that various user representations can cast content to and/or from virtual or real world devices, etc.), notes (e.g., sticky note virtual object, etc.), desk virtual objects. In this way, the AR workspace 601 may be configured to accommodate various virtual workspace scenarios, such as ambient desk presence, small meetings, large events, third person experiences, and/or the like.

The AR workspace 601 may include conference areas 602a-602b that have chair virtual objects around a conference table virtual object. Various user representations may join the conference areas 602a-602b by selecting a chair virtual object. A private permission may be required to be granted for a particular user representation to join the conference areas 602a-602b or the conference areas 602a-602b may be publically accessible. For example, the particular user representation may need a security token or credential associated with their corresponding VR/AR device to join the conference areas 602a-602b. A user may use a user input mechanism (e.g., cursor or pointer 414, controllers 270a-270b, hand 410, etc.) to instruct their corresponding user representation to move throughout the shared AR workspace 601. For example, the user may hold and move the controllers 270a-270b to control their user representation.

The controlled movement of their user representation may be indicated by the movement indicator 604. The movement indicator 604 can comprise a circular destination component to indicate where the user representation is instructed to move and a dotted line component to indicate the direction that the user representation is instructed to move. The movement indicator 604 can also be or include other suitable indicators that inform the user of how to move in the shared AR workspace 601. As discussed above, a format of a user representation may be selected by each user in the shared AR collaborative working environment. As an example, the user may select one of multiple avatars such as the female avatar 606a, the male avatar 606b, or some other suitable avatar or user representation. The user may customize the appearance of their user representation, such as by selecting clothes, expressions, personal features, and/or the like. As an example, the female avatar 606a is selected to have brown hair and wear a brown one piece of clothing. As an example, the male avatar 606b is selected to have a beard and wear a suit.

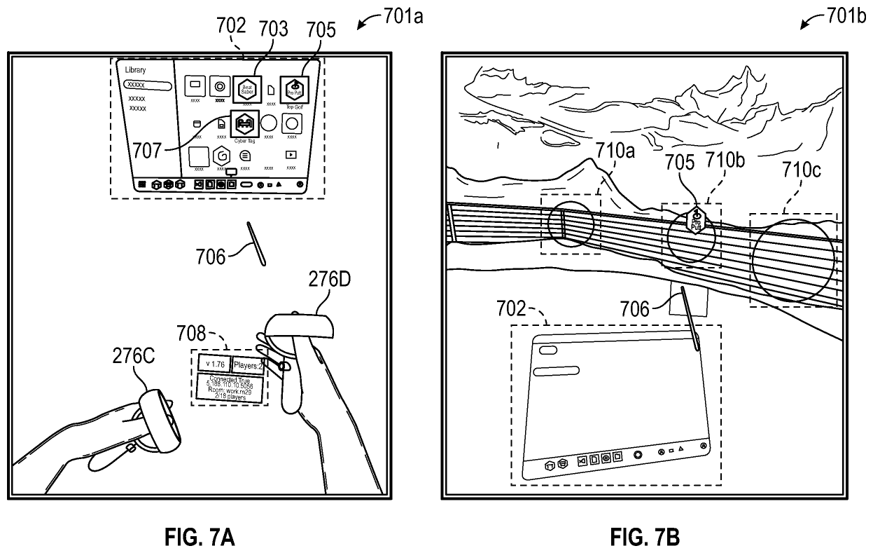

FIGS. 7A-7B illustrate example views of XR environments 701a-701b for selecting a link to AR content, according to certain aspects of the present disclosure. The XR environments 701a-701b may include one or more visual navigation elements 710a-710c that can function as links to AR content. The one or more visual navigation elements 710a-710c may be an orb, a cylindrical shape, a spherical shape, a shape, a map, an object, and/or the like, for example. The XR environment 701a shows configuration or initialization of the visual navigation elements 710a-710c. A user may use controllers 270a-270b (e.g., controller 276C corresponding to the user's left hand and controller 276D corresponding to the user's right hand) to select one or more AR applications (e.g., AR game applications, AR content sharing applications, AR music applications, AR word processing applications, AR design applications, etc.) in the AR application library screen 702. The AR application library screen 702 may contain multiple AR applications such as beat saber AR app 703, pro putt top golf AR app 705, cyber tag AR app 707, and/or the like. The multiple AR applications may be represented as graphical icons on the AR application library screen 702, such as a hexagon, square, circle or any other suitably shaped or configured graphical icon.

Movement of a pointer 706 may be controlled by user interaction with the controllers 270a-270b. This way, the pointer 706 may indicate which of the multiple AR applications are selected by the user. When the user causes the pointer 706 to hover over or be directed at a particular one of the multiple AR applications, information associated with the particular one AR application may be retrieved and displayed in an app info window 708. The app info window 708 may display information such as a version, player quantity information, connectivity information, and/or the like. For example, the app info window 708 can display that two players are playing pro putt top golf AR app 705 version 1.76 with address 5.188.110.10.5056 in playing room “work.rn29” that has a capacity of eighteen players. Rooms may be a way of categorizing or dividing a total number of users/players of a particular AR app into subsets.

The user may select AR applications to initiate or configure one or more visual navigation elements 710a-710c. For example, the user may use a user input mechanism (e.g., controllers 270a-270b, etc.) to drag graphical icons corresponding to selected AR applications to an empty one of the visual navigation elements 710a-710c. The visual navigation elements 710a-710c may be initialized as empty or may be pre-populated with AR apps, such as an AR app predicted for use by the user (e.g., based on user preferences, user history, etc.). For example, the user may use the controllers 270a-270b to drag and drop pro putt top golf AR app 705 to configure empty visual navigation element 710b with a link to pro putt top golf AR app 705. In this way, the empty visual navigation element 710b may be populated, transformed, or otherwise configured with the selected pro putt top golf AR app 705 such that the visual navigation element 710b becomes a link (e.g., deep link, contextual link, etc.) to the pro putt top golf AR app 705. The user may use some other suitable operation with the controllers 270a-270b or other user input aside from drag and drop to indicate a selection of the pro putt top golf AR app 705 or other AR app options.

The empty visual navigation elements 710a-710c may be pre-generated for a particular virtual area, such as the XR environment 701b. For example, the XR environments 701a-701b may be labeled as a personal workspace for the user such that a default setting (e.g., modifiable when the user is configuring their profile) specifies that three empty visual navigation elements 710a-710c should be generated and available for populating by a certain set of AR applications. Any default setting may be selected by the user, such as more, less, or equal to the quantity of the three visual navigation elements 710a-710c appearing in the XR environment 701b. The user may select a setting such that no visual navigation elements 710a-710c prior to an affirmative indication by the user. For example, the user may use the user input to request generation of one or more of the visual navigation elements 710a-710c.

The request may include specification of one or more particular AR applications to configure links for one or more visual navigation elements 710a-710c or the request may specify that the visual navigation elements 710a-710c should be empty. In response to the request, the computing system 100 or other suitable AR server/device may cause generation of one or more of the visual navigation elements 710a-710c. The generated visual navigation elements 710a-710c may be empty, configured with one AR application, or configured with multiple AR applications. If a given visual navigation element 710a-710c is configured with multiple AR applications, the user may be prompted with a choice of one or more of the multiple AR applications to load when the given visual navigation element 710a-710c is activated by the user.

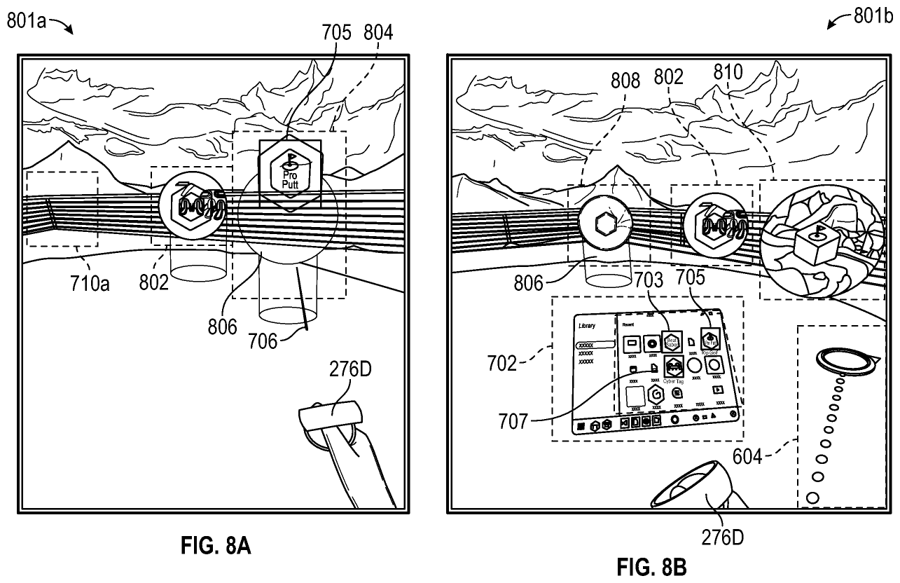

FIGS. 8A-8B illustrate example views of generating and activating a link to artificial reality content, according to certain aspects of the present disclosure. The XR environments 801a-801b show how a user can control the pointer 706 with the controllers 270a-270b to highlight or select a particular one of the visual navigation elements 710a-710c. For example, a given visual navigation element 710a-710c may be configured, selected, or activated by the user highlighting the given visual navigation element 710a-710c with the pointer 706. Also, the user may use other methods such as the user clicking on the navigation element with the controllers 270a-270b, the user walking towards the navigation element, the user sending an instruction to the computing system 100 or other suitable AR server/device to configure the given visual navigation element 710a-710c, or some other suitable configuration method. Configuration may refer to transforming one or more of the empty visual navigation element 710a-710c into a linked visual navigation element 710a-710c that when activated causes an activating party to transition into a linked AR application. For example, a configured visual navigation element 710a-710c can function as a deep link launch point that causes the user to launch into the linked AR application, such as the beat saber AR app 703, the pro putt top golf AR app 705, or the cyber tag AR app 707.

As an example, if the user has not purchased an AR application that requires a purchase, the user or a guest of the user may still be allowed to configure one of the visual navigation elements 710a-710c with the unpurchased AR application. As an example, if the user activates navigation element 710b that has been configured with a link to the pro putt top golf AR app 705 and the user has not purchased the pro putt top golf AR app 705 on their AR/VR connected device, then activation of the link may cause their AR/VR connected device to load a trial or demo version, a particular portion, a particular level, a particular layer, a particular destination and/or the like of the pro putt top golf AR app 705. As discussed above, the user may select AR applications to initiate or configure one or more visual navigation elements 710a-710c via a user input mechanism. For example, the XR environments 801a shows an AR app configuration process of visual navigation element 804. As an example, the user may use the pointer 706 to drag the pro putt top golf AR app 705 into visual navigation element 804 when it is empty. Upon being dragged into the visual navigation element 804, the pro putt top golf AR app 705 may cause a blue or other colored light 806 to glow, for example. In this way, the AR app activation process can involve highlighting the visual navigation element 804 as the visual navigation element 804 is being configured.

The user may use a user input mechanism to move the pointer 706 between different instances of the visual navigation elements 710a-710c. For example, the user may cause the pointer 706 to shift between the empty visual navigation element 710a, the configured visual navigation element 802, and the in-transition visual navigation element 804. As an example, the configured visual navigation element 802 may be configured with the cyber tag AR app 707 and the in-transition visual navigation element 804 may be in the process of being configured with the pro putt top golf AR app 705. The colored light 806 may indicate that the visual navigation element 804 is in-transition with configuration with the pro putt top golf AR app 705. As an example, when the colored light 806 fades, that may indicate that a corresponding visual navigation element has completed an AR app configuration process. For example, the configured visual navigation elements 802, 808, 810 may be decorated with an indication of their corresponding configured AR applications, such as being VR orbs having a graphical representation of their corresponding AR applications. In this way, the configured visual navigation element 802 may comprise a graphical representation of the cyber tag AR app 707, the configured visual navigation element 808 may comprise a graphical representation of the beat saber AR app 703, and the configured visual navigation element 810 may comprise a graphical representation of the pro putt top golf AR app 705.

The configured visual navigation elements 802, 808, 810 may be configured with AR applications that are selected from the AR application library screen 702, such as the beat saber AR app 703, the pro putt top golf AR app 705, and the cyber tag AR app 707, as discussed above. To activate a link of one or more of the configured visual navigation elements 802, 808, 810, the user may walk or travel over to a vicinity of the configured visual navigation elements 802, 808, 810 to activate a corresponding navigation element. The travel may be indicated or represented by the movement indicator 604. For example, the movement indicator 604 may indicate when the user travels to a launch point in the vicinity of the configured visual navigation element 810. When a user representation associated with the user walks to the launch point, this may cause the corresponding pro putt top golf AR app 705 to load for the user on a VR enabled device (e.g., HMD 200, tablet, smartphone, display screen, etc.). For example, the launch point may function as a deep link, contextual link, or prompt. As an example, the deep link may cause the user representation to transition to a loading screen (e.g., which may display a player's lobby, selection screen, etc.) of the pro putt top golf AR app 705, the contextual link may cause the user representation to transition directly into a portion of the pro putt top golf AR app 705 (e.g., a particular, a particular stage, a particular area where associated user representations such as friends and family are engaged in the pro putt top golf AR app 705, etc.), and the prompt may prompt the user to download or purchase the pro putt top golf AR app 705.

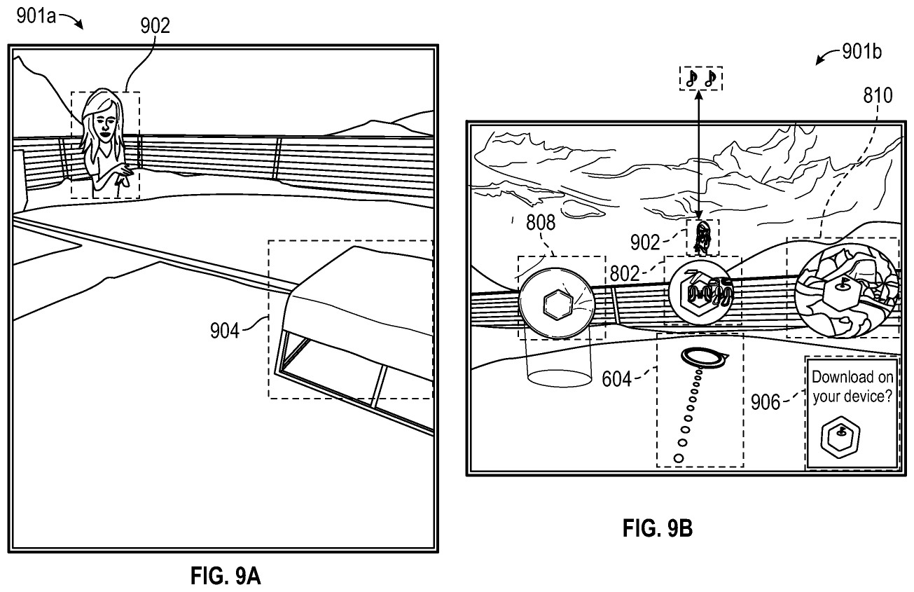

FIGS. 9A-9B illustrate example views of activating a link to artificial reality content according to a user representation 902 engaged in an artificial reality application, according to certain aspects of the present disclosure. For example, the user representation 902 may be a friend of a user of a shared XR environment including the XR environments 901a-901b. The XR environment 901a may be a personal workspace of the user. For example, the XR environment 901a may contain user selected virtual objects, mixed reality objects that track real world objects via a tracking component of the mixed reality HMD system 250, and/or other user selected settings of the XR environment 901a. As an example, the XR environment 901a may contain a mixed reality sofa 904 that is mapped or linked to a real world sofa of the user and/or real world carpet that the real world sofa is placed on. This way, when the user representation corresponding to the user interacts with the mixed reality sofa 904, the same interaction may be occurring between the user and the real world sofa. For example, the user representation sitting on the mixed reality sofa 904 may be reflected by the user sitting on the real world sofa via a position tracking component of the mixed reality HMD system 250. While the user is in the XR environment 901a, the user may receive an indication of associated user representations, such as selected or identified user representations corresponding to friends, family, and/or colleagues, for example. The indication of associated user representations may include status indications, location indications, progress indications, and/or the like such as an indication that the user representation 902 is located in the XR environment 901a.

In the XR environment 901b, the configured visual navigation elements 802, 808, 810 may have indications of user representations that interact with the corresponding navigation element. As an example, when user representation 902 is engaged in an AR application corresponding to a navigation element such as the cyber tag AR app 707, a graphical representation of the user representation 902 may be displayed in the vicinity of the corresponding navigation element. For example, the user representation 902 may hover over the configured visual navigation element 802 to indicate that the user representation 902 is actively engaged in the cyber tag AR app 707 corresponding to the configured visual navigation element 802. Similarly, if the user activates one of the configured visual navigation elements 802, 808, 810 such as the configured visual navigation element 808 such that the beat saber AR app 703 loads for the user on a user device, then the user's user representation can be displayed hovering above the configured visual navigation element 808.

As discussed above, when the movement indicates that the user's user representation is within the vicinity of the configured visual navigation element 802, this may activate a launch point and activate the configured visual navigation element 802 to cause the cyber tag AR app 707 to load for the user device. For example, the user device may load a purchased version (e.g., if previously purchased on the user device), a trial or demo version, a particular portion, a particular level, and/or the like of the cyber tag AR app 707. The particular portion or level may correspond to how/where the user representation 902 is currently engaged in the cyber tag AR app 707. As an example, the user representation 902 may correspond to a friend of the user such that the user's user representation may activate the link of the configured visual navigation element 802 to join the user representation 902 in the cyber tag AR app 707 or some other suitable AR app referenced by the link.

Prior to activation of the cyber tag AR app 707, the user may receive audio indications of or associated with the user representation 902. For example, the computing system 100 or other suitable AR server/device may cause sound of activity or engagement with the cyber tag AR app 707 (or other suitable AR app) to be propagated through the user's HMD 200 (or other AR/VR compatible user device etc.). This way, the audio indications may simulate, for the user, the sound of another associated user representation engaged in a particular AR app or AR area as being in “proximity” to the location of the user's user representation. In other words, the user may hear the sounds of their friends, family, or other associated users while those other users are engaged in the particular AR app or AR area that they are traveling to. Similarly, the user corresponding to the user representation 902 may hear sounds associated with the user's user representation, such as sounds of the user's user representation being engaged in the XR environment 901a. As an example, the user's user representation may be in direct audio communication with the user representation 902 even if they are not both located in the same AR area by virtue of their mutual association (e.g., in the same party, friendship, family status, colleague status, etc.). In this way, audio connection between associated users/user representations may be maintained throughout a shared XR environment.

The link of the configured visual navigation elements 802, 808, 810 may be used to directly launch the user's user representation to the same activity or location that those other users are currently engaged in. As an example, when the user travels to the launch point of configured visual navigation element 802, a prompt may be generated on the user's HMD 200 or other AR/VR compatible user device indicating that the computing system 100 or other suitable AR server/device will transition the user's user representation into the cyber tag AR app 707. This may allow the user to join their friend (e.g., user representation 902, etc.) in the cyber tag AR app 707. If the user has not purchased the cyber tag AR app 707 and payment is required before loading the AR app, a download prompt 906 may be displayed on a screen of the user's HMD 200 or other AR/VR compatible user device. The download prompt 906 may be generated to request that the user purchase the AR app and download it so that full access to the cyber tag AR app 707 or other suitable AR app may be granted to the user.

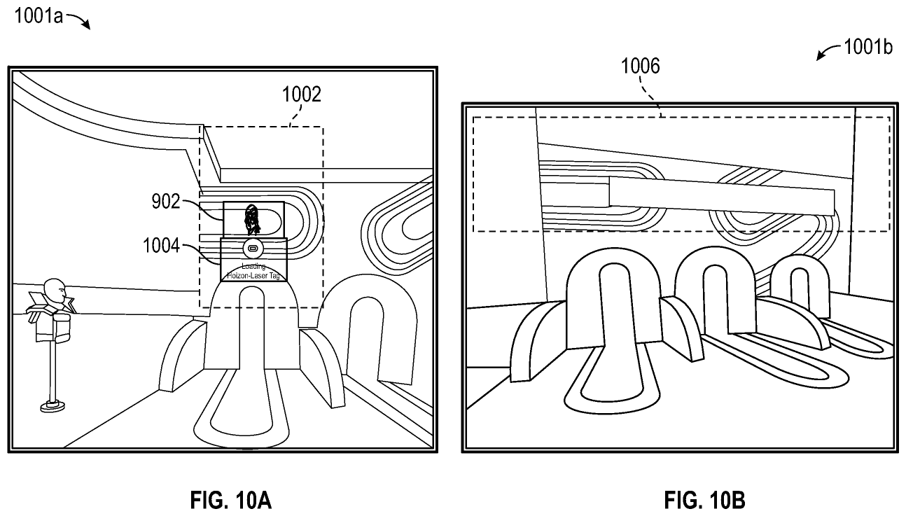

FIGS. 10A-10B illustrate example views of loading artificial reality content according to a user representation engaged in an artificial reality application, according to certain aspects of the present disclosure. The XR environments 1001a-1001b may illustrate a user/user representation transitioning or traveling from a first virtual area to a second virtual area upon activating a configured visual navigation element. For example, the first virtual area may contain the configured visual navigation elements 802, 808, 810. As an example, the XR environment 1001a may comprise a loading indication 1002, such as an AR app indication 1004 of a particular AR app linked by a particular visual navigation element. For example, the loading indication 1002 may comprise the AR app indication 1004 that indicates the cyber tag AR app 707 is loading. For example, the cyber tag AR app 707 may be loaded for the user at a “horizon” player's loading screen of the cyber tag AR app 707.

The user may have activated a contextual link of the configured visual navigation element 802 such that the user may be transitioned directly to a location of the user representation 902 inside of the cyber tag AR app 707. As discussed above, the user may receive audio indications of activity of the user representation 902 with respect to the cyber tag AR app 707 because of an association between the user and the user corresponding to the user representation 902. The audio indications may be transmitted via the user's HMD 200 (or other AR/VR compatible user device etc.). The audio indications may be heard by the user prior to a visual environment of the cyber tag AR app 707 being loaded for the user's user representation. For example, the user may visually see blue light or some other visual indication that the cyber tag AR app 707 is loading. That is, the user may receive audio indications of the activity of other associated users within a particular AR application prior to the user receiving visual indications of the particular AR application.

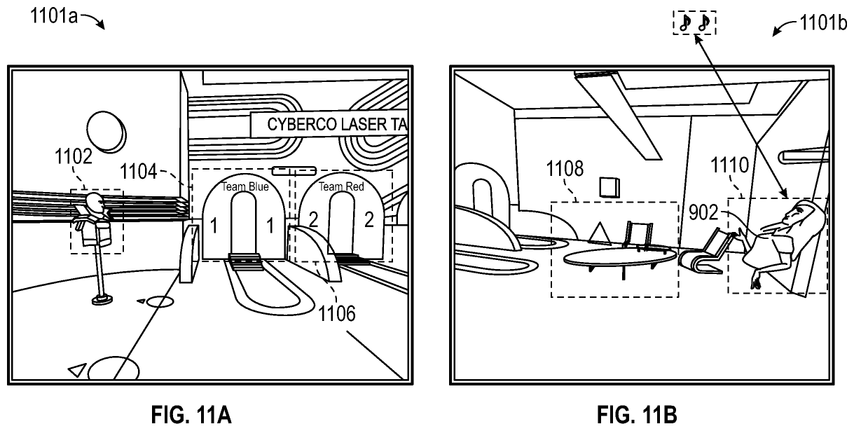

FIGS. 11A-11B illustrate example views of engagement in artificial reality content according to a user representation engaged in an artificial reality application, according to certain aspects of the present disclosure. The XR environments 1101a-1101b illustrate playing of or engagement with the cyber tag AR app 707. For example, the cyber tag AR app 707 can involve a staging area in which users are assigned to user representations that are grouped into teams. As an example, the teams may include a blue team and a red team. User representations can have an appearance corresponding to their team such as a blue colored user representation 1101 corresponds to the blue team. Similarly, red colored user representations may correspond to the red team. To select a team, the user representations present in the staging area prior to the start of a laser tag game may be assigned to a team such as at the team blue entrance 1104 or the team red entrance 1106. The assignment may be based on a random assignment scheme, a skill level assignment scheme, an association scheme (i.e., grouping associated user representations together), manual selection (i.e., each user represents selects a team via user input), and/or the like. The team assignments may be performed prior to an instance of a cyber tag game of the cyber tag AR app 707 being initiated or configured. Alternatively, when the cyber tag game is close to a start time, each user representation may travel (e.g., as indicated by a corresponding movement indicator) to the team blue entrance 1104 or the team red entrance 1106. A team quantity limit may be enforced such that team blue and team red each have the same or similar quantity of players/user representations on the team.

As discussed above, a user may activated a contextual deep link of the configured visual navigation element 802 such that the user may be transitioned directly to a location of the user representation 902 associated with user's user representation inside of the cyber tag AR app 707. The contextual aspect of the link of the configured visual navigation element 802 may refer to the computing system 100 or other suitable AR server/device causing automatic transition of the user's user representation to the same context of the user representation 902. As an example, the contextual deep link may link to a progress point of the user representation 902. The configured visual navigation element 802 may be a public visual navigation element, a private visual navigation element, and/or the like. If public, the contextual deep link of the configured visual navigation element 802 may be selected by any user or user representation (e.g., in the vicinity of configured visual navigation element 802), for example. If the element is private, the contextual deep link may be selectable only by (or visible only to) the user. For example, the contextual link may cause the user's user representation to automatically join team blue if the user's user representation has been assigned to team blue prior to the cyber tag game instance starting.

As an example, the contextual link may cause the user's user representation to wait at the staging area for the user representation 902 to complete a game so that the two associated user representations may play a game together. Audio indications 1110 of the user representation 902 being engaged in the cyber tag AR app 707 may be received by the user via the user's HMD 200 or other AR/VR compatible user device etc. As an example, audio indications 1110 of the user representation 902 being located in a mixed reality environment (e.g., outside of an AR application such as an AR waiting room) may be received by the user via the user's HMD 200 or other AR/VR compatible user device etc. This way, the user may hear the activity of other associated user representations and decide whether to activate links that transition the user to the same location as one or more of the other associated user representations. Moreover, the user may be audibly connected with the user representation 902 such that the user's user representation and the user representation 902 may engage in an audible conversation even though the two user representations are not in the same virtual area.

The audio indications 1110 or audio connection between associated user representations may advantageously maintain connections between associated user representations even when those representations are virtually distant from each other in an AR/VR setting. The user and other associated user representations may also send each other messages to communicate, such as verbal/audible messages, textual messages, and/or the like. The user may also receive system generated messages such as receiving an indication that associated user representations have activated a corresponding visual navigation element based on the message. The deep aspect of the link of the configured visual navigation element 802 may refer to the computing system 100 or other suitable AR server/device causing automatic loading of the referenced cyber tag AR app 707 on a VR/AR suitable user device.

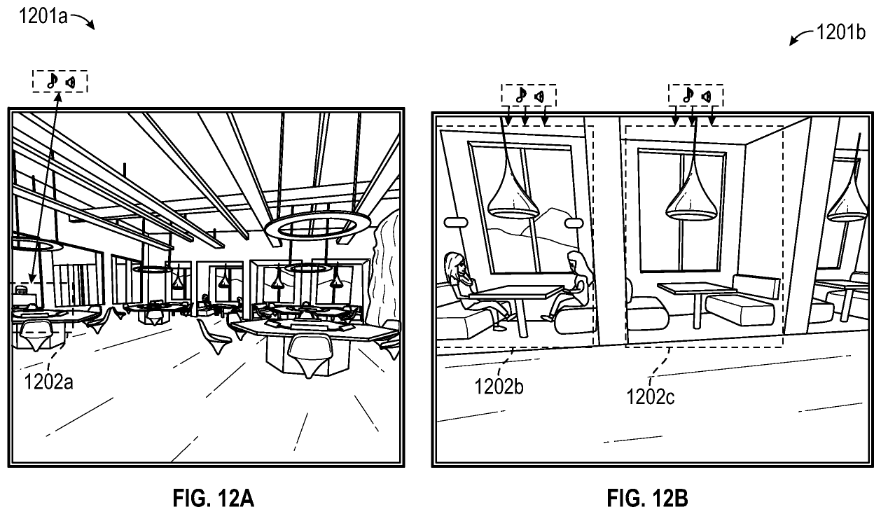

FIGS. 12A-12B illustrate example views of generating audio indications for user representations that are associated with each other, according to certain aspects of the present disclosure. The XR environments 1201a-1201b illustrate the presence of audio zones 1202a-1202c in which sound or audio is adjusted to simulate a real world audio environment such as a spatialized audio environment. For example, the audio zone 1202a may simulate a conference table setting. Various user representations may be assigned or select seat virtual objects around a conference table virtual object. The various user representations may be considered in the same audio zone 1202a such that audio sources inside the audio zone 1202a are emphasized and/or audio sources outside of the audio zone 1202a are deemphasized. Similarly, the XR environment 1201b depicts audio zones 1202b-1202c. As an example, the audio zones 1202b-1202c may simulate private adjacent booths at a public working space such as an office work space, a coffee shop workspace, and/or the like. That is, the audio zones 1202b-1202c can function as private spaces within a subset of a public space. For example, the public working space may comprise multiple user representations seated across or around each other on bench virtual objects.

For the multiple user representations, audio sources inside the audio zones 1202b-1202c can be emphasized and/or audio sources outside of the audio zones 1202b-1202c can be deemphasized. For example, sound emphasis may be added or removed based on sound adjustment, such as sound amplification, sound muffling, sound dampening, sound reflection and/or the like. As an example, the sound adjustment may include muffling or dampening distracting audio sources by the computing system 100 or other suitable AR server/device for each AR/VR connected device corresponding to user representations in the audio zones 1202b-1202c. Any audio source outside of the audio zones 1202b-1202c may be considered distracting and subject to muffling or dampening. Alternatively, a subset of audio sources outside of the audio zones 1202b-1202c may be considered distracting based on criteria such as type of audio source, audio content, distance of audio source from the audio zone, and/or the like. Also, the distracting audio may be reflected outwards (e.g., away from the audio zones 1202b-1202c). As an example, virtual sound waves may be modeled by the computing system 100 or other suitable AR server/device and cast or otherwise propagated in a direction facing away from the audio zones 1202b-1202c. In this way, the audio zones 1202b-1202c may be insulated from some undesired external sounds. Also, the audio zones 1202b-1202c may enable private conversations to be kept private, such as by avoiding being overheard by other users in the XR environments 1201a-1201b.

Conversely, the virtual sound waves from audio sources within the audio zones 1202b-1202c) may be propagated towards the audio zones 1202b-1202c, such as towards the user representations sitting around a table virtual object. For example, the virtual sound waves corresponding to conversation of the multiple user representations may be amplified and/or reflected inwards towards a center of the audio zones 1202a-1202c (e.g., which may correspond to a conference table simulation and a booth simulation, respectively). Other virtual sound waves that are directed towards one or more the audio zones 1202a-1202c may be characterized and adjusted in terms of its sound based on this characterization. For example, a virtual sound wave corresponding to speech from a first user representation located outside of the audio zones 1202c and associated (e.g., as a friend) with a second user representation may be amplified and/or reflected towards the audio zone 1202c. This type of virtual sound adjustment may be performed for each user representation individually so that sounds that are determined to be pertinent for each user representation are adjusted correctly. In this way, each user representation would not hear amplified sound from unassociated user representations or otherwise undesirable audio sources. The sound adjustment settings may be selected via an appropriate user input for each user/user representation. As an example, each user may select types of audio that are desired to be amplified, dampened, or otherwise modified in sound.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

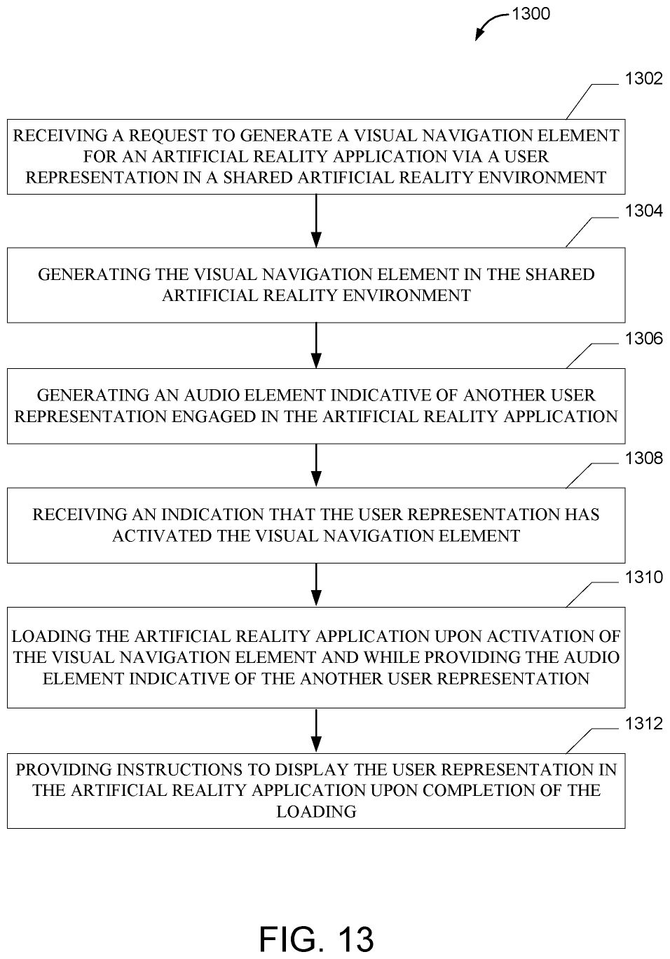

FIG. 13 illustrates an example flow diagram (e.g., process 1300) for activating a link to artificial reality content in a shared artificial reality environment, according to certain aspects of the disclosure. For explanatory purposes, the example process 1300 is described herein with reference to one or more of the figures above. Further for explanatory purposes, the steps of the example process 1300 are described herein as occurring in serial, or linearly. However, multiple instances of the example process 1300 may occur in parallel. For purposes of explanation of the subject technology, the process 1300 will be discussed in reference to one or more of the figures above.

At step 1302, a request to generate a visual navigation element (e.g., visual navigation elements 710a-710c) for an artificial reality application (e.g., beat saber AR app 703, pro putt top golf AR app 705, cyber tag AR app 707) configured to operate in the shared artificial reality environment can be received. For example, the request may be received via a user representation in a shared artificial reality environment. According to an aspect, the receipt of the request may comprise dragging a representation of the artificial reality application to an empty visual navigation element via an artificial reality gesture element.

At step 1304, the visual navigation element may be generated in the shared artificial reality environment. According to an aspect, the generation of the visual navigation element can comprise prompting (e.g., via download prompt 906), after providing display of the visual navigation element, user representations that are proximate to the user representation to download the artificial reality application. According to an aspect, the generation of the visual navigation element can comprise generating audio indications (e.g., audio indications 1110) of user representations engaged outside of the artificial reality application while the user representation is engaged in the artificial reality application. According to an aspect, the generation of the visual navigation element can comprise providing a representation (e.g., user representation 902) of the artificial reality application in the visual navigation element via an artificial reality gesture element.

At step 1306, an audio element indicative of another user representation engaged in the artificial reality application may be generated. For example, the audio element can be generated for the user representation. According to an aspect, the audio element may be indicative of a first user representation engaged in the artificial reality application. The audio element can be audible to a second user representation. According to an aspect, the process 1300 may include sending a message between the first user representation and the second user representation. For example, sending the message may comprise: sending the message from the first user representation to the second user representation to indicate an occurrence in the artificial reality application and/or sending the message from the second user representation to the first user representation to indicate an occurrence in a virtual area that is remote from the artificial reality application.

At step 1308, an indication that the user representation has activated the visual navigation element may be received. According to an aspect, the process 1300 may include receiving an indication that the second user representation has activated the visual navigation element based on the message. According to an aspect, the receipt of the indication may comprise determining at least one of: a version, a level, a portion, a layer, or a destination of the artificial reality application to load for the user representation.

At step 1310, the artificial reality application may be loaded for the user representation. The loading may occur upon activation of the visual navigation element and while providing the audio element indicative of the another user representation engaged in the artificial reality application. According to an aspect, loading the artificial reality application may be loaded for the second user representation upon activation of the visual navigation element and while providing the audio element indicative of the first user representation engaged in the artificial reality application. According to an aspect, the process 1300 may include sharing, based on moving an artificial reality object, content between the first user representation and the second user representation.

At step 1312, instructions to display the user representation in the artificial reality application may be provided upon completion of the loading. According to an aspect, the provision of the instructions may comprise providing display of the user representation at a spatial position proximate to the visual navigation element to indicate that the user representation is engaged in the artificial reality application.

According to an aspect, the process 1300 may further include providing access to the artificial reality application for users that are not associated with a security token for the artificial reality application. According to an aspect, the process 1300 may further include sending, to other user representations, audio associated with execution of the artificial reality application while the user representation is engaged in the artificial reality application. According to an aspect, the user representation comprises an avatar and the visual navigation element comprises at least one of: an orb, a cylindrical shape, a sphere, a doorway, a shape, a map, a custom object model, an object, or a geometric primitive that represents the linked content. According to an aspect, the visual navigation element (e.g., configured visual navigation elements 802, 808, 810) comprises at least one of: a contextual deep link that links to a progress point of the another user representation, a public visual navigation element, or a private visual navigation element.

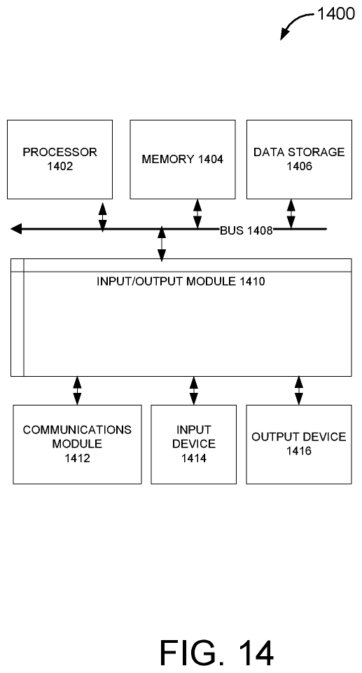

FIG. 14 is a block diagram illustrating an exemplary computer system 1400 with which aspects of the subject technology can be implemented. In certain aspects, the computer system 1400 may be implemented using hardware or a combination of software and hardware, either in a dedicated server, integrated into another entity, or distributed across multiple entities.

Computer system 1400 (e.g., server and/or client) includes a bus 1408 or other communication mechanism for communicating information, and a processor 1402 coupled with bus 1408 for processing information. By way of example, the computer system 1400 may be implemented with one or more processors 1402. Processor 1402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1400 can include, in addition to hardware, code that creates an execution environment for the computer program in question, e.g., code that constitutes processor firmware, a protocol stack, a database management system, an operating system, or a combination of one or more of them stored in an included memory 1404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1408 for storing information and instructions to be executed by processor 1402. The processor 1402 and the memory 1404 can be supplemented by, or incorporated in, special purpose logic circuitry.

The instructions may be stored in the memory 1404 and implemented in one or more computer program products, i.e., one or more modules of computer program instructions encoded on a computer-readable medium for execution by, or to control the operation of, the computer system 1400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1404 may also be used for storing temporary variable or other intermediate information during execution of instructions to be executed by processor 1402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1400 further includes a data storage device 1406 such as a magnetic disk or optical disk, coupled to bus 1408 for storing information and instructions. Computer system 1400 may be coupled via input/output module 1410 to various devices. The input/output module 1410 can be any input/output module. Exemplary input/output modules 1410 include data ports such as USB ports. The input/output module 1410 is configured to connect to a communications module 1412. Exemplary communications modules 1412 include networking interface cards, such as Ethernet cards and modems. In certain aspects, the input/output module 1410 is configured to connect to a plurality of devices, such as an input device 1414 and/or an output device 1416. Exemplary input devices 1414 include a keyboard and a pointing device, e.g., a mouse or a trackball, by which a user can provide input to the computer system 1400. Other kinds of input devices 1414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1416 include display devices such as an LCD (liquid crystal display) monitor, for displaying information to the user.

According to one aspect of the present disclosure, the above-described gaming systems can be implemented using a computer system 1400 in response to processor 1402 executing one or more sequences of one or more instructions contained in memory 1404. Such instructions may be read into memory 1404 from another machine-readable medium, such as data storage device 1406. Execution of the sequences of instructions contained in the main memory 1404 causes processor 1402 to perform the process steps described herein. One or more processors in a multi-processing arrangement may also be employed to execute the sequences of instructions contained in memory 1404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1400 can include clients and servers. A client and server are generally remote from each other and typically interact through a communication network. The relationship of client and server arises by virtue of computer programs running on the respective computers and having a client-server relationship to each other. Computer system 1400 can be, for example, and without limitation, a desktop computer, laptop computer, or tablet computer. Computer system 1400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1402 for execution. Such a medium may take many forms, including, but not limited to, non-volatile media, volatile media, and transmission media. Non-volatile media include, for example, optical or magnetic disks, such as data storage device 1406. Volatile media include dynamic memory, such as memory 1404. Transmission media include coaxial cables, copper wire, and fiber optics, including the wires that comprise bus 1408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1400 reads game data and provides a game, information may be read from the game data and stored in a memory device, such as the memory 1404. Additionally, data from the memory 1404 servers accessed via a network, the bus 1408, or the data storage 1406 may be read and loaded into the memory 1404. Although data is described as being found in the memory 1404, it will be understood that data does not have to be stored in the memory 1404 and may be stored in other memory accessible to the processor 1402 or distributed among several media, such as the data storage 1406.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for activating a link to artificial reality content in a shared artificial reality environment, the method comprising:
receiving, via a user representation in a shared artificial reality environment, a request to generate a visual navigation element for an artificial reality application configured to operate in the shared artificial reality environment;
generating the visual navigation element in the shared artificial reality environment;
generating, for the user representation, an audio element indicative of another user representation engaged in the artificial reality application;
receiving an indication that the user representation has activated the visual navigation element;
loading, upon activation of the visual navigation element and while providing the audio element indicative of the another user representation engaged in the artificial reality application, the artificial reality application for the user representation; and
providing instructions to display the user representation in the artificial reality application upon completion of the loading.

2. The computer-implemented method of claim 1, wherein receiving the request to generate the visual navigation element comprises dragging, via an artificial reality gesture element, a representation of the artificial reality application to an empty visual navigation element.

3. The computer-implemented method of claim 1, wherein generating the visual navigation element comprises prompting, after providing display of the visual navigation element, user representations that are proximate to the user representation to download the artificial reality application.

4. The computer-implemented method of claim 1, wherein generating the audio element comprises generating, while the user representation is engaged in the artificial reality application, audio indications of user representations engaged outside of the artificial reality application.

5. The computer-implemented method of claim 1, wherein receiving the indication that the user representation has activated the visual navigation element comprises determining at least one of: a version, a level, a portion, a layer, or a destination of the artificial reality application to load for the user representation.

6. The computer-implemented method of claim 1, wherein providing instructions to display the user representation in the artificial reality application upon completion of the loading comprises providing display of the user representation at a spatial position proximate to the visual navigation element to indicate that the user representation is engaged in the artificial reality application.

7. The computer-implemented method of claim 1, further comprising providing access to the artificial reality application for users that are not associated with a security token for the artificial reality application.

8. The computer-implemented method of claim 1, further comprising sending, to other user representations, audio associated with execution of the artificial reality application while the user representation is engaged in the artificial reality application.

9. The computer-implemented method of claim 1, wherein the user representation comprises an avatar and wherein the visual navigation element comprises at least one of: an orb, a cylindrical shape, a sphere, a doorway, a shape, a map, a custom object model, an object, or a geometric primitive that represents the linked content.

10. The computer-implemented method of claim 1, wherein the visual navigation element comprises at least one of: a contextual deep link that links to a progress point of the another user representation, a public visual navigation element, or a private visual navigation element.

11. A system for activating a link to artificial reality content in a shared artificial reality environment, comprising:
one or more processors; and
a memory comprising instructions stored thereon, which when executed by the one or more processors, causes the one or more processors to perform:
receiving a request to generate a visual navigation element for an artificial reality application configured to operate in the shared artificial reality environment;
generating the visual navigation element;
generating an audio element indicative of a first user representation engaged in the artificial reality application, wherein the audio element is audible to a second user representation;
sending a message between the first user representation and the second user representation;
receiving, based on the message, an indication that the second user representation has activated the visual navigation element;
loading, upon activation of the visual navigation element and while providing the audio element indicative of the first user representation engaged in the artificial reality application, the artificial reality application for the second user representation; and
providing instructions to display the user representation in the artificial reality application upon completion of the loading.

12. The system of claim 11, wherein the instructions that cause the one or more processors to perform generating the visual navigation element cause the one or more processors to perform providing, via an artificial reality gesture element, a representation of the artificial reality application in the visual navigation element.

13. The system of claim 11, wherein the instructions that cause the one or more processors to perform generating the visual navigation element cause the one or more processors to perform prompting, after providing display of the visual navigation element, user representations that are associated with the second user representation to download the artificial reality application.

14. The system of claim 11, wherein the instructions that cause the one or more processors to perform sending the message between the first user representation and the second user representation cause the one or more processors to perform:
sending, from the first user representation to the second user representation, the message to indicate an occurrence in the artificial reality application, or
sending, from the second user representation to the first user representation, the message to indicate an occurrence in a virtual area that is remote from the artificial reality application.

15. The system of claim 11, wherein the instructions that cause the one or more processors to perform receiving the indication that the second user representation has activated the visual navigation element cause the one or more processors to perform determining at least one of: a version, a level, a portion, a layer, or a destination of the artificial reality application to load for the second user representation.

16. The system of claim 11, wherein the instructions that cause the one or more processors to perform providing instructions to display the second user representation in the artificial reality application upon completion of the loading cause the one or more processors to perform providing display of the second user representation at a spatial position proximate to the visual navigation element to indicate that the second user representation is engaged in the artificial reality application.

17. The system of claim 11, further comprising stored sequences of instructions, which when executed by the one or more processors, cause the one or more processors to perform providing access to the artificial reality application for users that are not associated with a security token for the artificial reality application.

18. The system of claim 11, further comprising stored sequences of instructions, which when executed by the one or more processors, cause the one or more processors to perform sharing, based on moving an artificial reality object, content between the first user representation and the second user representation.

19. The system of claim 11, wherein the user representation comprises an avatar and wherein the visual navigation element comprises at least one of: an orb, a cylindrical shape, a sphere, a doorway, a shape, a map, a custom object model, an object, or a geometric primitive that represents the linked content.

20. A non-transitory computer-readable storage medium comprising instructions stored thereon, which when executed by one or more processors, cause the one or more processors to perform operations for providing a link to artificial reality content in a shared artificial reality environment, comprising:
receiving, via a user representation in a shared artificial reality environment, a request to generate a visual navigation element for an artificial reality application configured to operate in the shared artificial reality environment;
generating the visual navigation element in the shared artificial reality environment;
generating, for the user representation, an audio element indicative of another user representation engaged in the artificial reality application;
receiving an indication that the user representation has activated the visual navigation element;
loading, upon activation of the visual navigation element and while providing the audio element indicative of the another user representation engaged in the artificial reality application, the artificial reality application for the user representation; and
providing instructions to display the user representation in the artificial reality application upon completion of the loading.
